(19) United States
(12) Patent Application Publication
(10) Pub. No.: US 2014/0286125 A1
(43) Pub. Date: Sep. 25, 2014

(54) SEISMIC ACQUISITION METHOD AND APPARATUS

(71) Applicant: WESTERNGECO L.L.C., Houston, TX (US)

(72) Inventor: John QUIGLEY, Reigate (GB)

(73) Assignee: WESTERNGECO L.L.C., Houston, TX (US)

(21) Appl. No.: 14/217,530

(22) Filed: Mar. 18, 2014

Related U.S. Application Data
(60) Provisional application No. 61/803,385, filed on Mar. 19, 2013.

(51) Int. Cl. G01V 1/04; G01V 1/104

(52) U.S. Cl. CPC G01V 1/04; G01V 1/104
USPC 367/15; 367/14

(57) ABSTRACT

A system and method for performing a seismic survey. The system includes a first seismic source and a second seismic source configured for generating seismic signals. The first seismic source is configured for generating seismic signals ranging from about 4 Hz to about 120 Hz. The second seismic source is configured for generating seismic signals ranging from about 0 Hz to about 8 Hz. The system includes receivers to receive seismic data in response to seismic signals generated by the seismic sources.

### CROSS-REFERENCE TO RELATED APPLICATION

This application claims the benefit of U.S. Provisional Patent Application Ser. No. 61/803,385 filed Mar. 19, 2013, which is incorporated herein by reference its entirety.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

In the oil and gas industry, geophysical prospecting techniques are commonly used to aid in the search for and evaluation of subterranean hydrocarbon deposits. Generally, a seismic energy source is used to generate a seismic signal that propagates into the earth and is at least partially reflected by subsurface seismic reflectors (i.e., interfaces between underground formations having different acoustic impedances). The reflections are recorded by seismic detectors located at or near the surface of the earth, in a body of water, or at known depths in boreholes, and the resulting seismic data may be processed to yield information relating to the location of the subsurface reflectors and the physical properties of the subsurface formations.

The seismic signal generated by a seismic vibrator is a controlled wavetrain (i.e., a sweep), which is applied to the surface of the earth or in the body of water or in a borehole. In seismic surveying on land using a vibrator, to impart energy into the ground in a swept frequency signal, the energy is typically imparted by using a hydraulic drive system to vibrate a large weight (the reaction mass) up and down. The reaction mass is coupled to a baseplate in contact with the earth and through which the vibrations are transmitted to the earth. The baseplate also supports a large fixed weight, known as the hold-down weight. Typically, a sweep is a sinusoidal vibration of continuously varying frequency, increasing or decreasing monotonically within a given frequency range. The frequency may vary linearly or nonlinearly with time. Also, the frequency may begin low and increase with time in an upsweep, or it may begin high and gradually decrease in a downsweep.

### SUMMARY

Described herein are implementations of various technologies for a system for seismic surveying. The system may include a first seismic source configured for generating seismic signals ranging from about 4 Hz to about 120 Hz. The system may include a second seismic source configured for generating seismic signals ranging from about 0 Hz to about 8 Hz. The system may also include a plurality of receivers for receiving seismic data in response to the seismic signals generated by the first and second seismic sources.

Described herein are also implementations of various technologies for a method of performing a seismic survey operation. The method may include generating seismic signals ranging from about 4 Hz to about 120 Hz from a first seismic source at a first set of shot locations. The method may include generating seismic signals ranging from about 0 Hz to about 8 Hz from a second seismic source at a second set of shot locations. The first set of shot locations may be denser than the second set of shot locations. The method may include acquiring seismic data attributable to the seismic sources using seismic receivers.

Described herein are also implementations of various technologies for a non-transitory computer-readable medium having stored thereon computer-executable instructions which, when executed by a computer, cause the computer to perform various actions. The actions may include causing a first seismic vibrator to generate a first series of seismic signals ranging from about 4 Hz to about 120 Hz. The actions may include causing a second seismic vibrator to generate a second series of seismic signals ranging from about 0 Hz to about 8 Hz with a longer sweep time than the first series of seismic signals. The actions may include acquiring a first dataset attributable to the first seismic source. The actions may include acquiring a second dataset attributable to the second seismic source. The actions may include processing the first and second datasets.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates elements of a vibroseis seismic survey in accordance with implementations of various techniques described herein.

FIG. 2 illustrates a diagram of a system for producing a sweep signal in accordance with implementations of various techniques described herein.

FIG. 3 illustrates a view of an acquisition geometry in accordance with implementations of various techniques described herein.

FIG. 4 is a flow diagram of a method for generating, receiving, and processing seismic signals in accordance with implementations of various techniques described herein.

FIG. 5 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down;” “upper” and “lower;” “upwardly” and “downwardly;” “below” and “above;” and other similar terms indicating relative positions above or below a given point or element may be used in connection with some implementations of various technologies described herein.

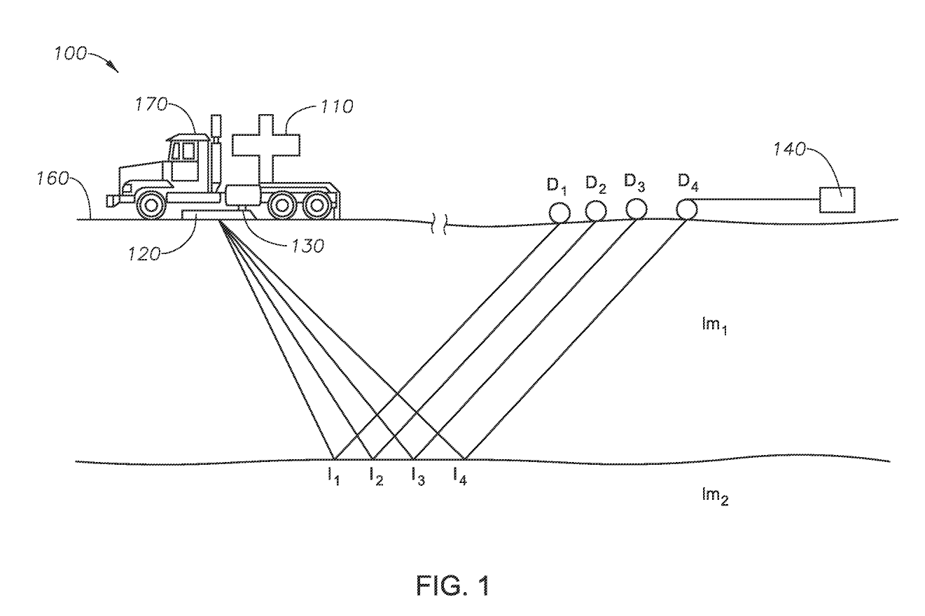

Various implementations described herein will now be described in more detail with reference to FIGS. 1-5.

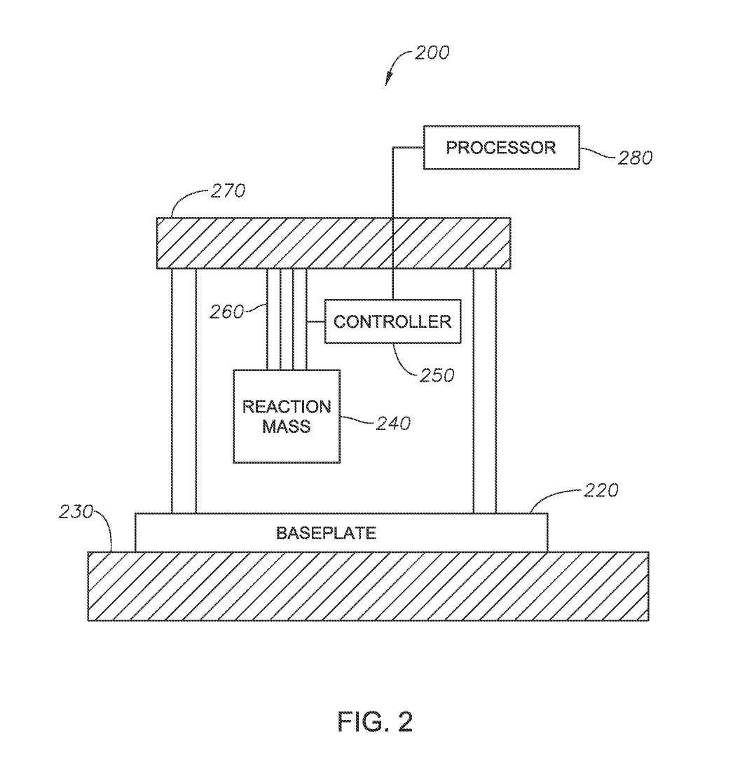

FIG. 1 illustrates in a simplified manner the elements of a vibroseis acquisition system in accordance with various implementations described herein. In the illustrated system, a seismic vibrator 100 includes a vibrating element 110, a baseplate 120 and a signal measuring apparatus 130, which may be for example, a plurality of accelerometers whose signals are combined to measure the actual ground-force signal applied to the earth by the seismic vibrator. The seismic vibrator 100 illustrated in FIG. 1 may be constructed on a truck 170 that provides for maneuverability of the system. As illustrated, the vibrating element 110 may be coupled with the baseplate 120 to provide for the transmission of vibrations from the vibrating element 110 to the baseplate 120. The baseplate 120 may be positioned in contact with an earth surface 160 and the vibrations of the vibrating element 110 may be communicated into the earth surface 160. One implementation of a vibrating element 110 is illustrated in FIG. 2 and described below.

The seismic signal that is generated by the vibrating element 110 and emitted into the earth, via the baseplate 120, may be reflected off the interface between subsurface impedances Im1 and Im2 at points I1, I2, I3, and I4. This reflected signal may be detected by geophones D1, D2, D3, and D4, respectively. The signals generated by the vibrating element 110 on the truck 100 may also be transmitted to a data storage 140 for combination with raw seismic data received from geophones D1, D2, D3, and D4 to provide for processing of the raw seismic data. In operation, a control signal, referred to also as pilot sweep, causes the vibrating element 110 to exert a variable pressure on the baseplate 120.

FIG. 2 illustrates a vibrating element and baseplate for producing a seismic signal in accordance with various implementations described herein. The seismic vibrator 200 includes a reaction mass 240 that is driven into motion by a driving force mechanism 260. The driving force mechanism 260 may be a hydraulic mechanism, a piston mechanism and/or the like. When driven into motion, the reaction mass 240 vibrates about a position of rest. The baseplate 220 provides a contact between the seismic vibrator 200 and the earth's surface 230 through which seismic signals may be emitted into the subsurface of the earth.

The motion of the reaction mass 240 may cause the baseplate 220 to come out of contact with the earth's surface 230 and, as such, the hold-down weight 270 may be coupled with the baseplate 220 to keep the baseplate 220 in contact with the earth's surface 230. The driving force mechanism 260 may move the reaction mass in a periodic type motion to create vibrations with different frequencies and these vibrations may be transferred into the earth's surface 230 by the baseplate 220. The driving force mechanism 260 may displace the reaction mass 240 periodically about a position where the reaction mass is at rest.

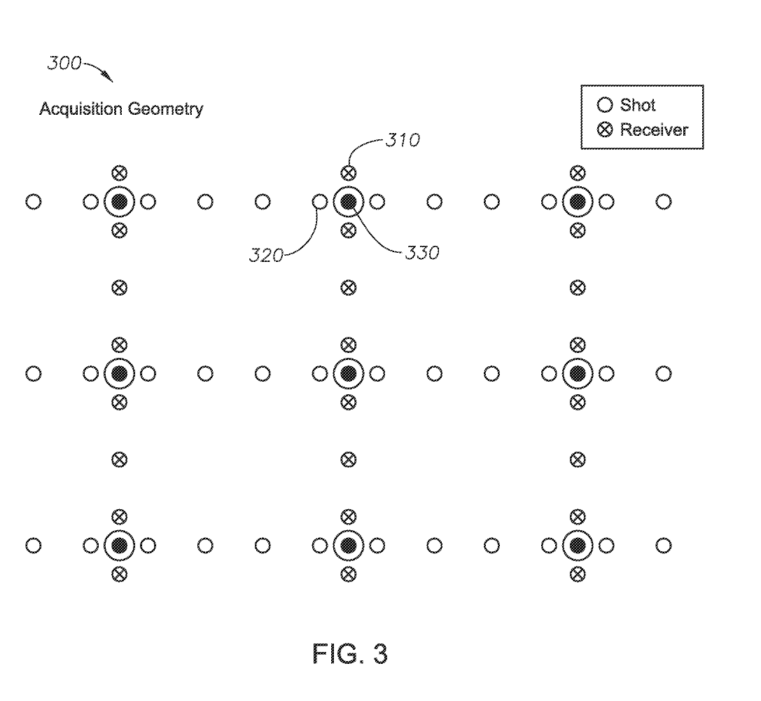

FIG. 3 illustrates a view of an acquisition geometry 300 in accordance with various implementations described herein. The acquisition geometry may have one or more seismic receivers placed at positions 310. The seismic receivers may be geophones, hydrophones, particle displacement sensors, particle velocity sensors, accelerometers, pressure gradient sensors, combinations thereof or any other type of seismic sensors.

At positions 320, also known as shot locations, a high frequency seismic signal ranging from about 4 Hz to about 120 Hz may be generated by a seismic source, such as a vibroseis source 100, an explosive type source, an impulsive source, a marine source, or any other type of seismic source. The high frequency seismic signal at positions 320 may be emitted for about 3 seconds to about 24 seconds at each position 320. This time period may be referred to as the sweep time.

At positions 330, a low frequency seismic signal ranging from about 0 Hz to about 8 Hz may be generated by a seismic source. The low frequency seismic signal at positions 330 may have a sweep time of about 20 seconds to about 120 seconds at each position 330. The seismic sources used at positions 320 and 330 may utilize Maximum Displacement Sweep technology, which is described in commonly assigned U.S. Pat. No. 7,974,154.

The high and low frequency signals emitted at positions 320 and 330 may be one continuous signal, or may be composed of multiple signal segments emitted within the frequency ranges. The signals may be of standard parametric (linear) design, maximum displacement design, pseudo-random design, or any other design. The high frequency and low frequency signals may be of different designs. In one example, the high frequency signals may be of standard parametric design whereas the low frequency signals may be of pseudorandom design.

In operations using acquisition geometry 300, multiple seismic signals may be emitted simultaneously by two or more sources. The signals may then be received by the seismic receivers simultaneously and may be filtered to separate the signals from the different sources. The sources may have different source signatures, wherein the source signature is the temporal and/or frequency distribution of the energy in the seismic signal. As such, the signals may be separated based on the source signatures. The total time required to complete a survey may be reduced if multiple signals are emitted simultaneously.

Positions 320 may be denser than positions 330, i.e., over the course of a seismic survey, more high frequency signals may be emitted than low frequency signals. In one implementation, the same seismic source or multiple sources with similar characteristics and functionality may be used at positions 320 and 330. For example, a single vibroseis truck may emit a high frequency signal at positions 330 and a low frequency signal at positions 320.

In another implementation, two types of seismic sources may be used, one for positions 320, and another for positions 330. That is, seismic sources specifically configured to generate high frequency seismic signals may be used for positions 320 while seismic sources specifically configured to generate low frequency seismic signals may be used for positions 330. The seismic source configured to generate low frequency signals may be a seismic source designed for low frequency signal generation. In one implementation, the low frequency seismic source may be a vibroseis source designed for low frequency signal generation. In another implementation, the low frequency seismic source may be an explosive source designed for low frequency signal generation. The signals may be emitted by any number of the two types of sources. For example, on a survey based on an acquisition geometry 300, the survey may be performed using three low frequency sources and two high frequency sources, and the positions 320 and 330 may be divided between the sources to reduce the time required to complete a survey using acquisition geometry 300.

Although positions 320 and 330 are illustrated in FIG. 3 as separate positions, in certain implementations these positions may overlap, for example, some of positions 320 may be the same as some of positions 330. In one implementation, source positions 330, source positions 320, or both may be located along the same axis as receiver positions 310. In another implementation, positions 330 may be located where the lines formed by source positions 320 and lines formed by receiver positions 310 intersect. It should be understood by one of skill in the art that FIG. 3 is an example of one acquisition geometry, and that positions 320 and positions 330 may be placed in other locations and implemented using different or other acquisition geometries. It should also be understood by one of skill in the art that although the low frequency signal is described as ranging from about 0 to about 8 Hz, the range may vary, e.g., the low end may be greater than 0 Hz and the high end may be greater than or less than 8 Hz. Likewise, the range for the high frequency signal may vary, e.g., the low end may be greater than or less than 4 Hz and its high end may be greater than or less than 120 Hz. Additionally, the sweep time of the low and high frequency signals may vary.

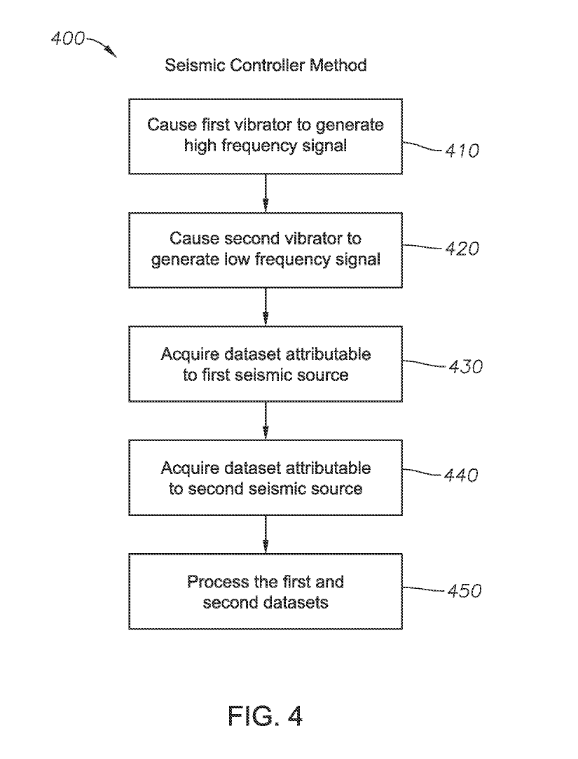

FIG. 4 illustrates a flow diagram of a method 400 for a seismic controller in accordance with implementations of various techniques described herein. In one implementation, method 400 may be performed by any computing device, such as computer 500, described below. It should be understood that while method 400 indicates a particular order of execution of operations, in some implementations, certain portions of the operations might be executed in a different order. Further, in some implementations, additional operations or steps may be added to method 400. Likewise, some operations or steps may be omitted. Additionally, the operations may be executed on more than one computer 500. For instance, block 410 may be executed on a first computer 500 connected to a first seismic vibrator 100, block 420 may be executed on a second computer 500 connected to a second seismic vibrator 100, and blocks 430-450 may be executed on a third computer 500 configured to receive input from seismic receivers.

As mentioned above, the computer 500 may be loaded with a set of instructions (software) to perform method 400. At block 410, the software may cause a first seismic vibrator 100 to generate a series of high frequency seismic signals. The high frequency seismic signals may have similar characteristics to those described above with reference to FIG. 3. At block 420, the software may cause a second seismic vibrator 100 to generate a series of low frequency seismic signals. The low frequency seismic signals may have similar characteristics to those described above with reference to FIG. 3. In one implementation, blocks 410 and 420 may be executed simultaneously. In another implementation, blocks 410 and 420 may be executed by the same seismic vibrator.

At blocks 430 and 440, the software may acquire datasets attributable to the first and second seismic sources. The software may acquire the datasets through the use of seismic receivers such as those described as being placed at positions 310. The software may acquire the datasets directly from the receivers, or the datasets may be transmitted to the software by another piece of software or another computer 500. The seismic receivers may record reflections of the signals emitted at blocks 410 and 420 as datasets. The seismic receivers may record reflections from multiple signals emitted simultaneously and then filter the recorded reflections to isolate the signals. The datasets acquired at blocks 430 and 440 may have different source signatures, different acquisition geometries, or both.

At block 450, the software may process the datasets acquired at blocks 430 and 440. The processing may include merging the acquired datasets. The merge may be accomplished using traditional methods, such as direct merging, or through new techniques tailored to the datasets collected by seismic controller method 400. The software may optimize the signal-to-noise ratio of the acquired datasets to improve processing at block 450. After processing, the resulting dataset or datasets may have greater bandwidth than either the dataset acquired at block 430 or the dataset acquired at block 440.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, and the like.

The various technologies described herein may be implemented in the general context of computer-executable instructions, such as program modules, being executed by a computer. Generally, program modules include routines, programs, objects, components, data structures, etc., that perform particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

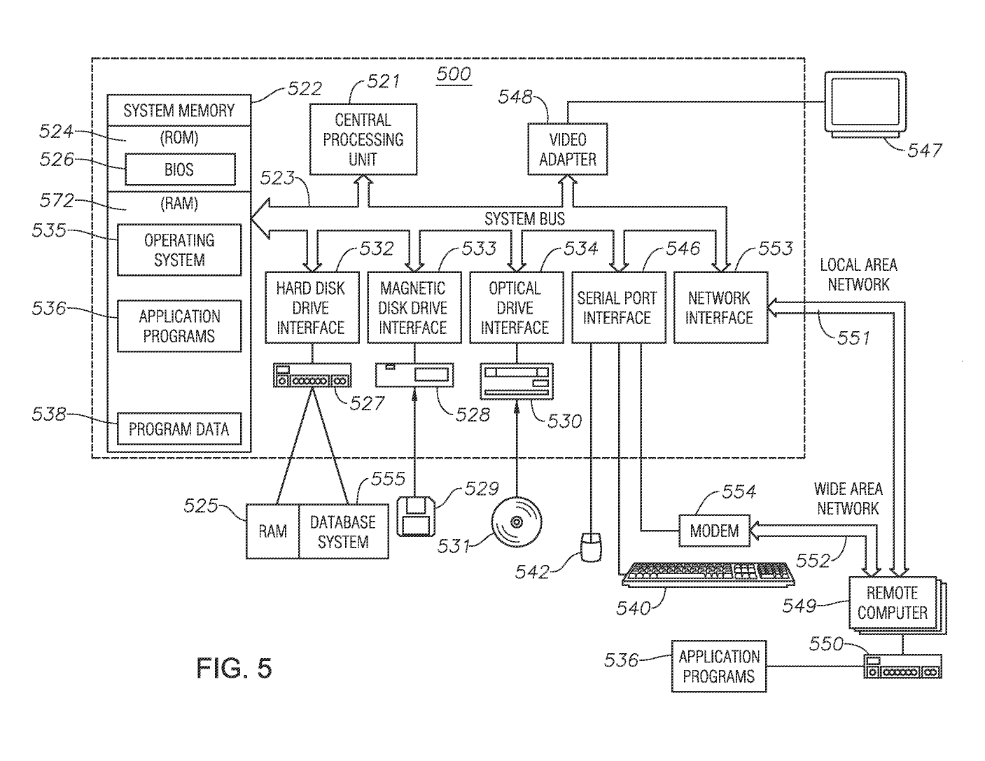

FIG. 5 illustrates a computer system 500 into which implementations of various technologies and techniques described herein may be implemented. Computing system 500 may be a conventional desktop, a handheld device, a controller, a server computer, an electronic device/instrument, a laptop, a tablet, or part of a seismic survey system. It should be noted, however, that other computer system configurations may be used.

The computing system 500 may include a central processing unit (CPU) 521, a system memory 522 and a system bus 523 that couples various system components including the system memory 522 to the CPU 521. Although only one CPU is illustrated in FIG. 5, it should be understood that in some implementations the computing system 500 may include more than one CPU. The system bus 523 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 522 may include a read only memory (ROM) 524 and a random access memory (RAM) 525. A basic input/output system (BIOS) 526, containing the basic routines that help transfer information between elements within the computing system 500, such as during start-up, may be stored in the ROM 524. The computing system may be implemented using a printed circuit board containing various components including processing units, data storage memory, and connectors.

The computing system 500 may further include a hard disk drive 527 for reading from and writing to a hard disk, a magnetic disk drive 528 for reading from and writing to a removable magnetic disk 529, and an optical disk drive 530 for reading from and writing to a removable optical disk 531, such as a CD ROM or other optical media. The hard disk drive 527, the magnetic disk drive 528, and the optical disk drive 530 may be connected to the system bus 523 by a hard disk drive interface 532, a magnetic disk drive interface 533, and an optical drive interface 534, respectively. The drives and their associated computer-readable media may provide nonvolatile storage of computer-readable instructions, data structures, program modules and other data for the computing system 500.

Although the computing system 500 is described herein as having a hard disk, a removable magnetic disk 529 and a removable optical disk 531, it should be appreciated by those skilled in the art that the computing system 500 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 500. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 527, magnetic disk 529, optical disk 531, ROM 524 or RAM 525, including an operating system 535, one or more application programs 536, program data 538, and a database system 555. The one or more application programs 536 may contain program instructions configured to perform method 400 according to various implementations described herein. The operating system 535 may be any suitable operating system that may control the operation of a networked personal or server computer, such as Windows® XP, Mac OS® X, Unix-variants (e.g., Linux® and BSD®), and the like.

A user may enter commands and information into the computing system 500 through input devices such as a keyboard 540 and pointing device 542. Other input devices may include a microphone, joystick, game pad, satellite dish, scanner, user input button, or the like. These and other input devices may be connected to the CPU 521 through a serial port interface 546 coupled to system bus 523, but may be connected by other interfaces, such as a parallel port, game port or a universal serial bus (USB). A monitor 547 or other type of display device may also be connected to system bus 523 via an interface, such as a video adapter 548. In addition to the monitor 547, the computing system 500 may further include other peripheral output devices such as speakers and printers.

Further, the computing system 500 may operate in a networked environment using logical connections to one or more remote computers 549. The logical connections may be any connection that is commonplace in offices, enterprise-wide computer networks, intranets, and the Internet, such as local area network (LAN) 551 and a wide area network (WAN) 552. The remote computers 549 may each include application programs 536 similar to that as described above. The computing system 500 may use a Bluetooth radio to wirelessly communicate with another device.

When using a LAN networking environment, the computing system 500 may be connected to the local network 551 through a network interface or adapter 553. When used in a WAN networking environment, the computing system 500 may include a modem 554, wireless router or other means for establishing communication over a wide area network 552, such as the Internet. The modem 554, which may be internal or external, may be connected to the system bus 523 via the serial port interface 546. In a networked environment, program modules depicted relative to the computing system 500, or portions thereof, may be stored in a remote memory storage device 550. It will be appreciated that the network connections shown are exemplary and other means of establishing a communications link between the computers may be used.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A seismic surveying system, comprising:
a first seismic source configured for generating seismic signals ranging from about 4 Hz to about 120 Hz;
a second seismic source configured for generating seismic signals ranging from about 0 Hz to about 8 Hz; and
a plurality of receivers for receiving seismic data in response to the seismic signals generated by the first seismic source and the second seismic source.

2. The seismic surveying system of claim 1, wherein a sweep time for the first seismic source is less than a sweep time for the second seismic source.

3. The seismic surveying system of claim 1, wherein the first seismic source has a sweep time ranging from about 3 seconds to about 24 seconds and the second seismic source has a sweep time ranging from about 20 seconds to about 120 seconds.

4. The seismic surveying system of claim 1, wherein an acquisition geometry of the first seismic source is different from an acquisition geometry of the second seismic source.

5. The seismic surveying system of claim 1, wherein a source signature of the first seismic source is different from a source signature of the second seismic source.

6. The seismic surveying system of claim 1, wherein the first and second seismic sources are selected from a group consisting of vibroseis sources, explosive type sources, impulsive sources, and marine seismic sources.

7. The seismic surveying system of claim 1, wherein the shot locations of the first seismic source are more dense than the shot locations of the second seismic source.

8. The seismic surveying system of claim 1, wherein at least a portion of the shot locations of the first seismic source are the same as the shot locations of the second seismic source.

9. The seismic surveying system of claim 1, wherein the first seismic source and the second seismic source are the same device.

10. A method of performing a seismic survey operation, comprising:
generating seismic signals ranging from about 4 Hz to about 120 Hz from a first seismic source at a first set of shot locations;
generating seismic signals ranging from about 0 Hz to about 8 Hz from a second seismic source at a second set of shot locations, wherein the first set of shot locations is more dense than the second set of shot locations; and
acquiring seismic data attributable to the first and second seismic sources using seismic receivers.

11. The method of claim 10, wherein the acoustic signals generated by the first seismic source have a sweep time ranging from about 3 seconds to about 24 seconds and the acoustic signals generated by the second seismic source have a sweep time ranging from about 20 seconds to about 120 seconds.

12. The method of claim 10, wherein at least a portion of the first set of shot locations are the same as locations in the second set of shot locations.

13. The method of claim 10, wherein the first seismic source is different from the second seismic source.

14. The method of claim 10, wherein the first seismic source and the second seismic source are the same device.

15. The method of claim 10, wherein the first seismic source and the second seismic source emit seismic signals simultaneously.

16. The method of claim 10, wherein an acquisition geometry of the first seismic source is different from an acquisition geometry of the second seismic source.

17. A non-transitory computer-readable medium having stored thereon computer-executable instructions which, when executed by a computer, cause the computer to:
cause a first seismic vibrator to generate a first series of seismic signals ranging from about 4 Hz to about 120 Hz;
cause a second seismic vibrator to generate a second series of seismic signals ranging from about 0 Hz to about 8 Hz with a longer sweep time than the first series of seismic signals;
acquire a first dataset attributable to the first seismic source;
acquire a second dataset attributable to the second seismic source; and
process the first and second datasets.

18. The non-transitory computer-readable medium of claim 17, wherein the first seismic vibrator and the second seismic vibrator are the same device.

19. The non-transitory computer-readable medium of claim 17, wherein the first seismic vibrator and the second seismic vibrator are engaged simultaneously.

20. The method of claim 17, wherein the first series of seismic signals has a sweep time ranging from about 3 seconds to about 24 seconds and the second series of seismic signals has a sweep time ranging from about 20 seconds to about 120 seconds.
